(19) United States
(12) Patent Application Publication
(10) Pub. No.: US 2013/0038238 A1
(43) Pub. Date: Feb. 14, 2013

(54) PULSED OPERATION OF A DISCHARGE LAMP

(71) Applicants: Michael Haacke, Aachen (DE); Lars Dabringhausen, Baesweiler (DE); Edwin Theodorus Maria De Koning, Coevorden (NL); Jeroen Balm, Helmond (NL)

(72) Inventors: Michael Haacke, Aachen (DE); Lars Dabringhausen, Baesweiler (DE); Edwin Theodorus Maria De Koning, Coevorden (NL); Jeroen Balm, Helmond (NL)

(73) Assignee: KONINKLIJKE PHILIPS ELECTRONICS N.V., EINDHOVEN (NL)

(21) Appl. No.: 13/642,154

(22) PCT Filed: Apr. 12, 2011
(86) PCT No.: PCT/IB2011/051562

§ 371 Date: Oct. 19, 2012

(30) Foreign Application Priority Data
Apr. 21, 2010 (EP) 10160554.1

(51) Int. Cl. H05B 41/39

(52) U.S. Cl. 315/287

(57) ABSTRACT

A discharge lighting assembly and a method of operating a discharge lamp 10 are described. The discharge lamp 10 includes a discharge vessel 20 with two electrodes 24 for forming an arc discharge. A driver circuit 12 supplies electrical power to the lamp 10 as an alternating lamp current I_{L} and/or an alternating lamp voltage U_{L} with a commutation between half periods of positive and negative values. The driver circuit 12 is controlled to be able to deliver at a predetermined delivery time t_{D} of 10-100 μs after commutation a voltage level Up which varies in dependence on the lifetime L of the lamp 10.

### FIELD OF THE INVENTION

The present invention relates to the field of discharge lamps and more specifically to a discharge lighting assembly and a method of operating a discharge lamp.

### BACKGROUND OF THE INVENTION

In a discharge lamp, light is generated from an arc discharge ignited between two electrodes in a discharge vessel. Discharge lamps, specifically high pressure gas discharge lamps are used in numerous lighting applications today, specifically for automotive front lighting.

For high pressure gas (Xenon) discharge lamps, it is known to operate the lamps in a discharge lighting assembly which includes, besides the discharge lamp itself, an ignition circuit for supplying a high ignition voltage to start the lamp, a driver circuit for supplying electrical power to the lamp and a controller to control operation of the driver circuit.

WO 95/35645 A1 describes a method and circuit arrangement for operating a high pressure discharge lamp. To avoid flicker due to an unstable arc in a high pressure discharge lamp operated with an AC current, a current pulse is generated in a latter part of each half period of the lamp current. This raises the temperature of the electrode and increases the stability of the discharge arc. The ratio between the mean amplitude of the current pulse and the mean amplitude of the lamp current is between 0.6 and 2 and the ratio between the duration of the current pulse and half a period of the lamp current is between 0.05 and 0.15.

It is an object of the present invention to propose a discharge lighting assembly and a method for operating a discharge lamp where favorable operating conditions are obtained in a simple way.

### SUMMARY OF THE INVENTION

The inventors have considered details of commutation, i.e. current reversal in a discharge lamp driven with an alternating current. It was found that in many discharge lighting assemblies, specifically those with discharge lamps of reduced average operating power of 20-30 W and relatively thick electrodes of a material which does not comprise a solid state emitter, commutation may be critical. In order to achieve stable operation, the driver electronics thus need to be carefully designed to provide electrical power in a way that stable commutation may be achieved. However, safe electrical designs dimensioned large enough to always obtain successful commutation may be exaggerated in the dimensioning of their components.

In view of these considerations, the problem is solved by a discharge lighting assembly according to claim 1 and a method of operating a discharge lamp according to claim 15. Dependent claims refer to preferred embodiments of the invention.

According to the invention, electrical power is supplied to the lamp as alternating current and/or alternating voltage with a commutation between half periods of positive and negative values thereof. Preferred frequencies range at about 100-800 Hz. A preferred waveform of the current and/or voltage supplied to the lamp is substantially rectangular, i. e. except for the short commutation time where the polarity is changed from negative to positive or vice versa, the current and/or voltage remain essentially constant (which may be defined e. g. as varying less than +/−10%, preferably less than 5% in magnitude) for the largest part (e. g. more than 70%, preferably more than 80%) of each half period.

The alternating current and/or voltage is supplied by a driver circuit under control of a controller. The thus controlled driver circuit has a certain dynamic voltage delivery capability, or short dynamic capability, which in the present context is defined as a deliverable voltage level at a predetermined delivery time shortly after commutation. The delivery time regarded here is chosen close to a desired time of re-ignition of an arc between the electrodes of the lamp. However, as will be understood from the explanation of the preferred embodiment, actual re-ignition may take place shortly before or after the chosen fixed delivery time. Thus, the delivery time is proposed here primarily as a measure to evaluate the dynamic capability of the driver circuit and should be chosen at about 10-100 microseconds (μs) after commutation. The preferably regarded value of a delivery time t_{D} is 50 μs.

The dynamic voltage delivery capability of the driver corresponds to the driver voltage which may maximally be delivered at the delivery time. As will be appreciated by the skilled person, this maximum available voltage is limited by the electrical component design of the driver circuit as well as by the control thereof. In operation of a discharge lighting assembly, a voltage will be supplied by the driver for operation of the lamp, i. e. re-ignition of the arc after commutation. This re-ignition may happen already at quite low voltage values, which means that the driver need not supply the full deliverable voltage level. However, if re-ignition requires a higher voltage level, the dynamic voltage delivery capability of the driver circuit as controlled by the controller determines whether the voltage level required for re-ignition may be delivered at the delivery time or not. If a high enough voltage level is not delivered at the delivery time, re-ignition may be postponed or fail completely.

According to the present invention, the dynamic voltage delivery capability of the driver, i. e. the voltage level it is able to deliver at the delivery time, is not entirely constant over the lamp lifetime. This is achieved by controlling the driver circuit to achieve different dynamic voltage delivery capabilities at different values of lifetime of the lamp, i. e. specifically different values of accumulated burning hours since manufacture of the lamp.

The present inventors have found that the required re-ignition voltage of the lamp may change over the lamp lifetime. Usually lamp re-ignition takes place at lower voltages for a newly manufactured lamp. While individual re-ignition voltage values may differ, the mean re-ignition voltage generally increases over the lamp lifetime. Thus, a driver circuit with a fixed dynamic voltage delivery capability may be able to securely drive a lamp only up to a certain lamp lifetime. If the required re-ignition voltage of the lamp reaches the maximally deliverable voltage level of the driver circuit, re-ignition may fail.

The solution according to the invention, where the dynamic voltage delivery capability of the driver circuit is not constant over the lamp lifetime, but may vary by way of control of the driver circuit, allows a properly adapted design of the driver circuit. Measures for obtaining high dynamic capabilities of the driver circuit will have disadvantages, such as high electrical outlay of the components of the driver circuits, possibly increased electrical losses etc. Since the invention proposes a variable approach, such disadvantages need not be fully present throughout the whole lifetime of the lamp. Thus, it may be sufficient to achieve a higher dynamic capability only towards a higher age of the lamp.

In the present context, the varying dynamic capability of the driver circuit for different values of lifetime of the lamp may be achieved directly, e.g. by determining the number of hours of operation of the lamp since manufacture and by controlling the driver circuit differently in direct dependence on the thus determined lamp lifetime, e. g. by using a lookup-table of lamp lifetime values and adapted control parameters. However, it is alternatively also possible to achieve a variable behaviour indirectly, i. e. by controlling the driver circuit in accordance with another parameter which may itself vary over the lamp lifetime, such as e. g. the lamp current or the lamp voltage.

According to a preferred embodiment of the invention, the driver circuit is controlled by a controller, preferably working in a closed control loop, to deliver a lamp current or voltage according to a set value. The controller will thus operate the driver circuit to deliver a lamp current and/or voltage to minimize a control deviation between the set value and the actually delivered current/voltage value. It is preferred to control the lamp current rather than a voltage.

In the preferred embodiment, the set value comprises superimposed pulses to obtain higher dynamic voltage delivery capacity. A pulse may be defined as a distinct raising and subsequent lowering of the magnitude of the set value as compared to a basic waveform, such as the preferred rectangular waveform of the set value.

The present inventors have considered that controlling a driver circuit with pulses has disadvantages, such as increased power loss in the driver, electrical repercussions on the board net load and possible implications on internal operation of the discharge lamp, such as increased electrode burn-back. However, the dynamic capability of the driver circuit may significantly be influenced by such pulses. In order to achieve the desired variation of the dynamic voltage delivery capability, the pulse height, which also may be defined relative to the basic waveform, according to the preferred embodiment is not constant throughout operation of the lamp, but varies in dependence on the lifetime of the lamp.

By choosing the pulse height in dependence on the lifetime, a simple solution is presented that allows to adjust the dynamic voltage delivery capability of the driver circuit according to the specific operating situation of the lamp. This allows to adjust the dynamic capability as operating conditions of the lamp change over lifetime. Thus, in a very simple and flexible way, it is possible to choose the pulse height in each operation situation to be as high as necessary to achieve stable operation but still small enough to avoid excessive disadvantages. Specifically, in many cases where the dynamic capability of the driver circuit is already sufficient, operation without pulses is safely possible.

The pulses used are located in time after commutation, preferably shortly after commutation, i. e. within a time interval of at most 30% of the half period after polarity change, preferably within less than 20%. Additionally, pulses before commutation may be provided.

Generally, pulses may be defined in each half period, although it should be understood, as will be clear from the description of preferred embodiments, that the pulse height may be chosen such that no pulse is applied in some intervals, such as in an initial burning interval of a lamp.

In preferred embodiments, the dynamic voltage delivery capability of the driver circuit may be influenced more specifically such that higher dynamic capability is achieved at later lifetimes. Further preferred, the dynamic capability increases monotonously at least in an interval of the lamp lifetime, further preferred over the whole life-time. For the preferred way of influencing the dynamic capability by providing pulses of different height, this means that within the total lifetime of the lamp there is at least a first, earlier time and a second, later time where the pulse height at the first, earlier time is lower than at the second, later time. For example, it is preferred that at a lamp lifetime of 2500 h the pulse height is higher than at the beginning of the lifetime. It is further preferred that the pulse height increases within an interval between the first and the second time, or even over the whole lifetime monotonously, i. e. the pulse height is never below the preceding value. Especially preferred, there is at least one interval during the lifetime of the lamp, where the value of the pulse height increases strongly monotonously over the lamp lifetime, which increase may have a varying or constant (linear) slope.

According to a further embodiment of the invention, the lamp may be driven with pulses of increasing pulse height or width at least within a lifetime interval to obtain a higher luminous flux. In many lamps, lamp efficiency and thus the luminous flux obtained from a constant electrical power will decrease over the lamp lifetime, at least within intervals thereof. For example, for intervals of 500 h of lamp lifetime, a loss of lamp efficiency of e. g. some 2-10 lumens per Watt may be observed if the lamp is driven with constant electrical operation condition. The loss may vary between intervals in early lamp life or later lifetime. According to the preferred embodiment, this effect is countered by providing, at least within a lifetime interval of e. g. more than 300 h, preferably 900 h or more, pulses of increasing pulse height or width. These pulses may be the same pulses provided after commutation to ensure stable re-ignition of the lamp as discussed above. Alternatively or in addition thereto the increasing pulses may be provided at other times during each half period of the respective lifetime interval. Providing longer and/or higher current pulses increases the lamp efficiency. By providing increasing pulses, the loss of efficiency over the lifetime of the lamp may be reduced, so that at the end of the respective interval the lamp efficiency obtained with the increasing pulses will be higher than in a comparative example operated with no or constant pulses. Particularly preferred, the effect of loss of lamp efficiency in the respective interval may be compensated by specifically choosing the increase in pulse height according to the determined loss of efficiency such that an at least substantially constant efficiency may be obtained within the interval. In the present context, substantially constant efficiency is assumed if for a lifetime interval of 500 h the lumen efficiency in lumens per Watt varies by no more than 4 lm/W, further preferably 2 lm/W.

According to a further preferred embodiment, no pulses are provided in an initial interval of the lamp lifetime. After the end of the initial interval, pulses are then provided which may have a fixed or variable pulse height. In this way, unnecessary pulse operation is avoided. The initial interval, where no pulses are provided, may have a short duration of e. g. 300 h or more, however, it is also possible to have a much longer initial interval without pulses of 1000 h or more, or even 2000 h or more.

As will become apparent in the discussion of a preferred embodiment, in a preferred application a curve of pulse height PH over lamp lifetime may be defined between curves of minimum and maximum values. Further, a curve of preferred values may be defined. For example, for a lifetime of 500 h of the lamp, the pulse height may be chosen at 100%-210%, preferably at +/−20% of a proposed optimum value of 120%. At 2250 h, the pulse height is preferably 110%-225%, further preferred 160%+/−20%. The discharge lamp according to a preferred embodiment is a discharge lamp with a nominal power below 40 W, especially preferred 20-30 W. The lamp is driven by the driver circuit at its nominal power. The invention specifically applies to discharge lamps with a discharge vessel of small volume of 30 ul or less, especially preferred 12-25 μl. The preferred lamp has a filling of a rare gas, such as Xenon, of a cold pressure of 10-20 bar and metal halides, which may be provided in a preferred quantity of 100-400 μg and may further preferably comprise NaI and ScI₃. The lamp is preferably free of mercury. Further, the invention preferably applies to lamps with cylindrical electrodes of a diameter of 150-400 μm, preferably out of Thorium free tungsten material.

The width of the pulses provided may be e. g. 1%-25% of the duration of a half period. Preferred values are less than 20%, preferably less than 15%.

### BRIEF DESCRIPTION OF THE DRAWINGS

These and other aspects of the invention will be apparent from and elucidated with reference to the embodiments described hereinafter, where

FIG. 1 shows a schematical side view of a discharge lamp;

FIG. 2 shows a circuit diagram of a discharge lighting arrangement including a lamp and a driver circuit;

FIG. 3a, 3b show schematical diagrams illustrating I_{L}, U_{L} and U_{D};

FIG. 4a, 4b show timing diagrams of a set current value with different commutation pulses;

FIG. 5 shows a diagram of required reignition voltage over lifetime L;

FIG. 6 shows a diagram showing a pulse height PH over lifetime L

FIG. 7 shows a diagram of dynamic voltage delivery capability depending on pulse height;

FIG. 8 shows a diagram of dynamic voltage delivery capability depending on pulse width;

FIG. 9 shows a diagram of lamp efficiency loss over lifetime L.

### DETAILED DESCRIPTION OF EMBODIMENTS

The invention relates to a method and device for driving a discharge lamp and to a corresponding assembly including the lamp and driver. In the following, an embodiment of such an assembly and corresponding method of operation will be described for automotive use in a vehicle head light. However, it should be understood that the invention is not limited thereto and that it is not intended to exclude lamps for non-automotive use.

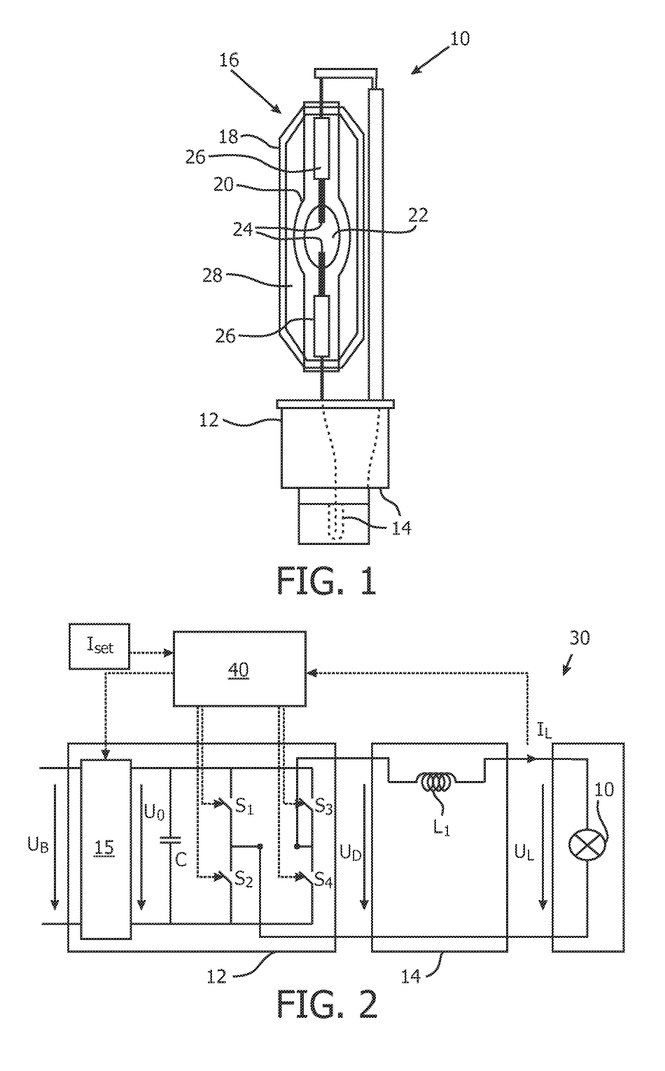

FIG. 1 shows in a side view a high pressure gas discharge lamp 10. The lamp comprises a base 12 with two electrical contacts 14 which are internally connected to a burner 16.

The burner 16 is comprised of an outer bulb 18 of quartz glass surrounding a discharge vessel 20. The discharge vessel 20 is also made of quartz glass and defines an inner discharge space 22 with projecting, cylindrical (rod-shaped) electrodes 24. The glass material from the discharge vessel further extends in longitudinal direction of the lamp 10 to seal the electrical connections to the electrodes 24 which comprise flat molybdenum foils 26.

The outer bulb 18 is, in its central portion, of cylindrical shape and arranged around the discharge vessel 20 at a distance, thus defining an outer bulb space 28. The outer bulb space 28 is sealed.

Generally, the discharge vessel 22 comprises a filling of a rare gas and metal halides. The outer bulb space 28 has a gas filling of preferably reduced pressure (below 1000 mbar) to achieve a defined, limited heat conduction.

As will be appreciated by the skilled person, high pressure gas discharge lamps of the type shown are know per se in different shapes, sizes and wattages. The present invention is primarily focused on low power automotive lamps of less than 40 W nominal power, preferably between 20 and 30 watt nominal power. The lamps have a filling in the discharge vessel 20 which is free of mercury.

Specifically, embodiments of the invention will be described in view of a sample 25 W lamp, which may be characterized by the following parameters:
Discharge vessel: elliptical or cylindrical inner and outer shape with inner diameter 2.2 mm and outer diameter 5.5 mm, discharge vessel volume 19.5 μl
Discharge vessel filling: Xenon of 14 bar cold pressure, 200 μg halides comprising NaI, ScI₃ and optionally other halides
Electrodes: rod shaped, diameter 250 μm, electrode distance 3.9 mm optical.
Electrode material: Tungsten, Th free.
Outer bulb: sealed and filled with gas at reduced pressure.

FIG. 2 shows a discharge lighting assembly 30 including a driver circuit 12, a controller 40, an ignition circuit 14, and a lamp 10.

As known to the skilled person, a discharge lamp 10 of the type shown in FIG. 1 is ignited by applying a high voltage between the electrodes 24 for generating an arc discharge. After ignition, the lamp 10 is driven in a run-up sequence with high current. After completion of the run-up sequence of about 60 seconds, the lamp 10 is driven in a steady-state with an alternating lamp current I_{L} of at least substantially rectangular waveform. The magnitude of the lamp current I_{L} is adjusted by a closed-loop feedback control to regulate the time average electrical power to the nominal value of, in the preferred example, 25 W. The lifetime L of the lamp is measured in hours of operation since manufacture. As known to the skilled person, standard sequences for tests directed to the lifetime L of a discharge lamp include continuously turning the lamp off and back on again after cooling to simulate real operation cycles.

As will be appreciated by the skilled person, the components of the assembly 30 are shown in a simplified manner, where some elements have been omitted. Thus, a complete ignition circuit comprises a high voltage transformer to generate the ignition voltage. Since ignition circuits are known per se to the skilled person and since the present invention deals with steady-state behavior of the lamp 10, the ignition circuit 14 is shown in FIG. 2 to only comprise an inductance L₁ corresponding to the secondary side of a high voltage transformer (not shown) of the ignition circuit 14. Since the remaining components of the ignition circuit are inactive in steady-state, only the inductance L₁ is relevant here.

The voltage U_{L} at the lamp 10 is supplied by the driver circuit 12 as a driver voltage U_{D} applied to the series connection of the inductance L₁ of the ignition circuit 14 and the lamp 10.

As shown in FIG. 2, the driver circuit 12 comprises in the preferred example a DC/DC converter 15 and a full bridge switching configuration with switches S₁-S₄. An input direct board voltage U_{B} of e. g. 12 V is converted in the DC/DC converter 15 to a controlled direct voltage U₀ of about 400 V open-circuit voltage. Operation of the DC/DC converter 15 is controlled, preferably by controlling at least one switching element therein, by controller 40. As will be appreciated by the skilled person, different types of DC/DC switching converter circuits are known which can be used to obtain a controlled output voltage U₀. The controlled direct voltage U₀, filtered by a capacitance C, is converted to the desired alternating voltage Uᵣ) of substantially rectangular wave-form by switches S₁-S₄ in a full bridge configuration. The switches S₁-S₄ may be semi-conductor switching elements such as FETs.

The driver circuit 12 is controlled by the controller circuit 40 such that a lamp current I_{L} is achieved in accordance with a set current value Iₛₑₜ. The set current value Iₛₑₜ is supplied by an outer control loop (not shown) to drive the lamp 10 at a constant electrical power of in the present example 25 W. The controller circuit 40 receives a measurement of the lamp current I_{L} and drives the DC/DC converter 15 and the switches S₁-S₄ to minimize a control deviation I_{L}-Iₛₑₜ. Controller 40 acts in a closed-loop control to continuously adjust the voltage U₀ and to open and close switches S₁, S₄ for a positive and switches S₂, S₃ for a negative driver output voltage U. As known per se to the skilled person, controller 40 thus controls the lamp current I_{L} in accordance with a set value Lₛₑₜ.

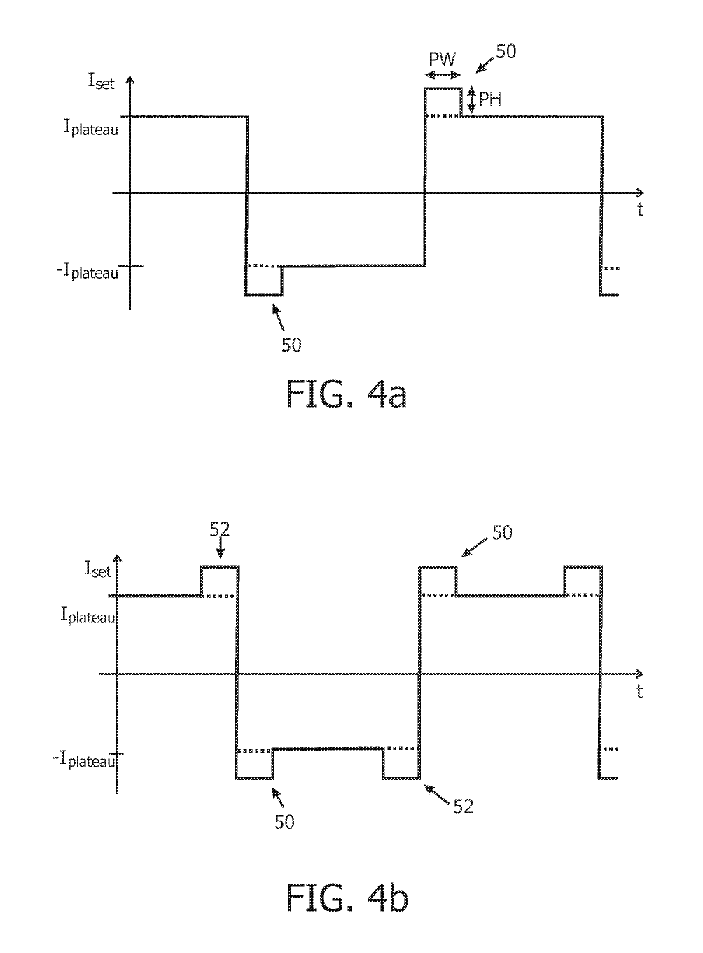

FIGS. 4a, 4b show the time variation of a set current value Iₛₑₜ for different embodiments of the present invention. Generally, the waveform of the set current Iₛₑₜ is rectangular as shown in dotted lines, i. e. it commutates with a commutation frequency of 400 Hz in the present example, where in each half period the current value Iₛₑₜ remains essentially constant at a value Iₚₗₐₜₑₐᵤ, which has the same magnitude but reverse polarity for adjoining half periods.

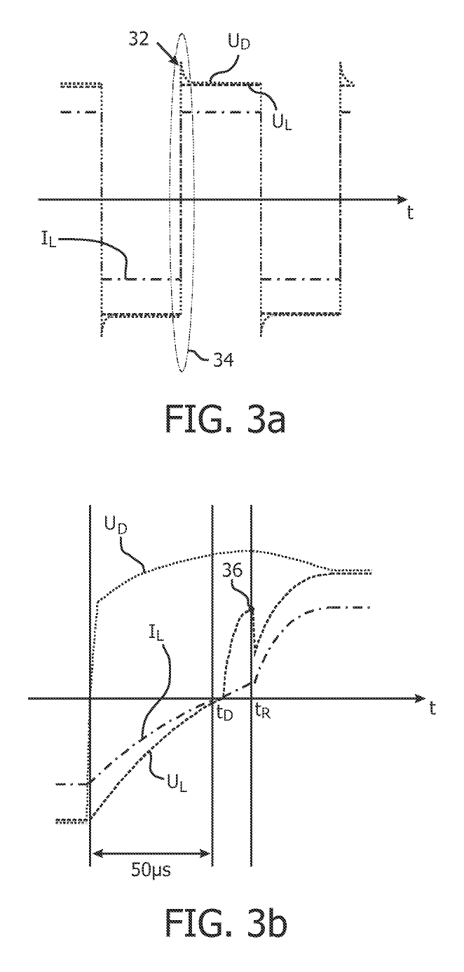

FIG. 3a shows for a correspondingly controlled driver circuit 12 the variation of the driver voltage Uᵣ) over time in steady-state operation of the lamp 10 as well as the resulting current I_{L} and voltage U_{L} at the lamp. The driver voltage Uᵣ) is shown in a dotted line, the lamp voltage U_{L} in a dashed line and the lamp current I_{L} in a slash dotted line.

Generally, U_{D}, U_{L} and I_{L} have substantially rectangular waveforms, i. e. they remain essentially constant between commutations, i. e. reversal of polarity. In the preferred embodiment, the lamp 10 is operated at 400 Hz, so that each half period has a duration of 1.25 ms. During the constant part of each half period an essentially constant arc is present between the electrodes 24 of the lamp 10. Upon commutation, the arc is shortly extinguished and then rapidly re-ignited with reverse polarity.

As shown in FIG. 3a, the driver voltage U_{D} shows a small voltage peak 32 directly after each commutation.

The time variation of U_{D}, U_{L} and I_{L} around commutation, i. e. within a time period 34, as indicated in FIG. 3a, is shown in FIG. 3b with an enlarged time scale. As visible here, the driver voltage U_{D} changes polarity quickly upon commutation. However, since U_{D} is applied to the series connection of the inductance L₁ and the lamp 10, the current I_{L} only changes steadily due to the inductance L₁. Also, the lamp voltage U_{L} changes slowly until the arc extinguishes.

Thereafter, the continuously applied driver voltage U_{D} achieves to raise the lamp voltage U_{L} up to a re-ignition point 36 at a time t_{R} after commutation, at which an arc of reversed polarity is again ignited. After re-ignition, the lamp current I_{L} rises quickly until the lamp voltage U_{L} and the lamp current I_{L} reach the constant part of the respective half period, where the lamp voltage U_{L} is equal to the driving voltage U_{D}. As visible in FIGS. 3a, 3b the driver voltage U_{D} delivered comprises a peak or pulse 32 delivered shortly after each commutation. Thus, the voltage U_{D} is higher in a short time interval after commutation than in the remaining half period.

However, it has been found that commutation of a discharge lamp 10 as described above is not always successful. In operation of a discharge lamp 10, situations may arise where an arc is not successfully re-ignited, such that the lamp may extinguish. The present inventors have found that such commutation problems may result from changes that result from aging of the lamp 10.

In operation of a discharge lamp 10 over a long period of time of several hundreds of hours, the lamp changes its properties over lifetime L. The changes to the lamp 10 include possible burn back at the electrodes 24 as well as mechanical changes to the discharge vessel 20 and chemical changes to the filling contained therein. The present inventors have established in experiments that commutation problems in discharge lamps are more likely to occur later in lamp life L.

The inventors have investigated re-ignition of the lamp after commutation in steady-state (re-ignition point 36 at t=t_{R} in FIG. 3b). The re-ignition voltage required at the point 36 is dependent on lamp parameters, especially on parameters of the electrodes 24. Specifically, the present inventors have found that the required re-ignition voltage is higher for thicker electrodes and for electrodes out of a material which does not comprise a solid state emitter, such as Thorium.

Specifically, the inventors have found that the required re-ignition voltage is dependent on the lamp lifetime. For the above described sample lamp, experiments were conducted to measure the required re-ignition voltage in dependence on a lamp lifetime L. It was found that while lamp samples in early life may show successful re-ignition at low voltages such as e. g. 30 V already, a required voltage may be significantly higher in later lamp life and reach values of e. g. 70-90 V at more than 2000 h.

The actual re-ignition time t_{R} may vary. However, it is preferable to keep t_{R} low, e. g. below 100 μs.

As visible in the circuit diagram of FIG. 2, the driver voltage U_{D} is applied to the series connection of the inductance L₁ and the lamp 10. Thus, the driver 15 needs to supply a driver voltage U_{D} which is at least equal to the sum of the voltage drop over the inductance L₁ and the required re-ignition voltage of the lamp 10. The voltage drop over the inductance L₁ may vary depending on the inductance value of typically between 0.5 and 1.5 mH, the current value I_{L} and the time until re-ignition t_{R}. A good estimate for the voltage drop may be 10-20 V.

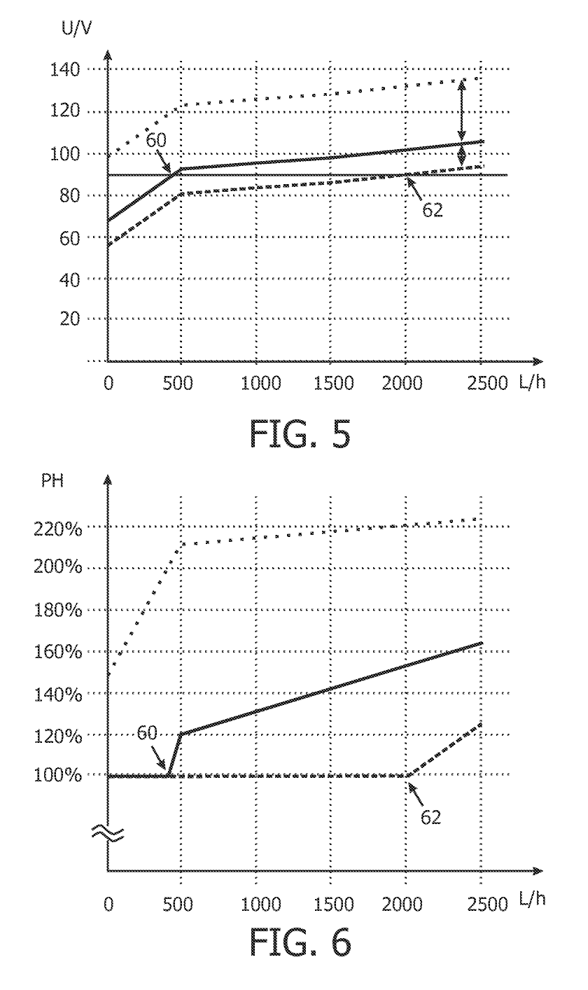

FIG. 5 shows a curve of a required driver voltage U_{D} over lamp lifetime L. Here, a solid line shows a mean required re-ignition voltage. A maximum curve is shown in dotted line, a minimum curve in a dashed line. The mean curve of FIG. 5 represents the experimentally found re-ignition voltage of a sample lamp dependent on the lamp lifetime plus an estimated voltage drop over the inductance L₁. The actual values where found to vary statistically from the mean values shown in FIG. 5. Together with the different estimates for the voltage drop over the inductance L₁, the shown minimum and maximum curves where determined.

Further, the dynamic behavior of the driver circuit 12 was determined. As shown in FIG. 3b, the output voltage U_{D} of the driver circuit changes polarity quickly and is then raised in order to achieve the desired positive value of the lamp current I_{L}. But while FIG. 3b shows an example of a commutation and re-ignition without problems, a higher required re-ignition voltage in later lamp life (see FIG. 5) may prevent successful re-ignition of the arc if the driver voltage U_{D} is not high enough to deliver the necessary re-ignition voltage (and additionally the voltage drop over the inductance L₁).

The driver circuit 12 thus needs to be able to supply a sufficiently high driver voltage U_{D} to secure re-ignition. The ability of the driver circuit 12 to supply a certain voltage level U_{D} quickly after commutation is the dynamic voltage delivery capability of the driver circuit 12. For a given driver circuit 12, this dynamic voltage delivery capability may be found as the maximum voltage deliverable at a defined delivery time t_{D} after commutation. In the present context, as shown in FIG. 3b, a fixed delivery time t_{D} of 50 μs will be regarded. The fixed delivery time t_{D} may substantially correspond to an expected re-ignition time t_{R}, but since actual values for t_{R} may vary, t_{D}, and t_{R} will certainly not always be the same.

As discussed, the driver circuit 12 is controlled in accordance with the lamp current I_{L} and a set value herefor, Lₛₑₜ.

For control according to a rectangular set value Iₛₑₜ as shown in dotted lines in FIG. 4a, 4b, the driver circuit 12 has a fixed dynamic voltage delivery capability, i. e. a constant maximum voltage that may be delivered at the regarded delivery time t_{D}. In the present example, this voltage level corresponds to 90 V as shown in the horizontal line in FIG. 5. Thus, for the lighting arrangement of FIG. 2, the driver circuit 12, as controlled according the rectangular Iₛₑₜ may only supply a maximum voltage of up to 90 V at a time t_{D} 50 μs after commutation.

As visible from FIG. 5 for the measured curve of mean required re-ignition voltages (solid line), this means that for an initial period of about 450 h, the driver circuit 12 will be able to supply a high enough driver voltage U_{D} to the ignition circuit 14 and the lamp 10. Thus, in this initial period of 450 h, no commutation problems are to be expected.

However, at point 60 in FIG. 5, the required re-ignition voltage of the lamp 10 exceeds the 90 V deliverable by the driver 12. Thus, from the point 60 on, the driver 12 may not succeed in timely re-igniting the lamp 10, such that the lamp may extinguish.

In the solid lines shown in FIG. 4a, 4b, an alternative set current value Iₛₑₜ is shown, where on the rectangular waveform of the set current Iₛₑₜ, pulses 50 are superimposed which in the first example of FIG. 4a are applied shortly after commutation. The pulses 50 may be defined by their pulse width PW, their pulse height PH and position in time relative to the time of commutation. Here, the following definitions will be used:

The pulse width will be defined relative to the duration of a half period of the current Iₛₑₜ in percent. While the measurement of the pulse width is clear in the case of fully rectangular pulses as shown in FIG. 4a, 4b, the pulse width PW should be measured between half maximum points in case of other shapes.

The pulse height PH shall be defined as a current value Iₛₑₜ during the pulse relative to the plateau current Iₚₗₐₜₑₐᵤ in percent. In the case of pulse shapes differing from the rectangular pulse, the current maximum shall be regarded.

As shown in FIG. 4a for a first embodiment, the pulses 50 are applied directly after commutation. This prompts the closed-loop control of controller 40 in FIG. 2 to quickly raise the driver voltage U_{D} after commutation.

In an alternative second embodiment of FIG. 4b, pulses are applied both before (pulses 52) and after (pulses 50) commutation.

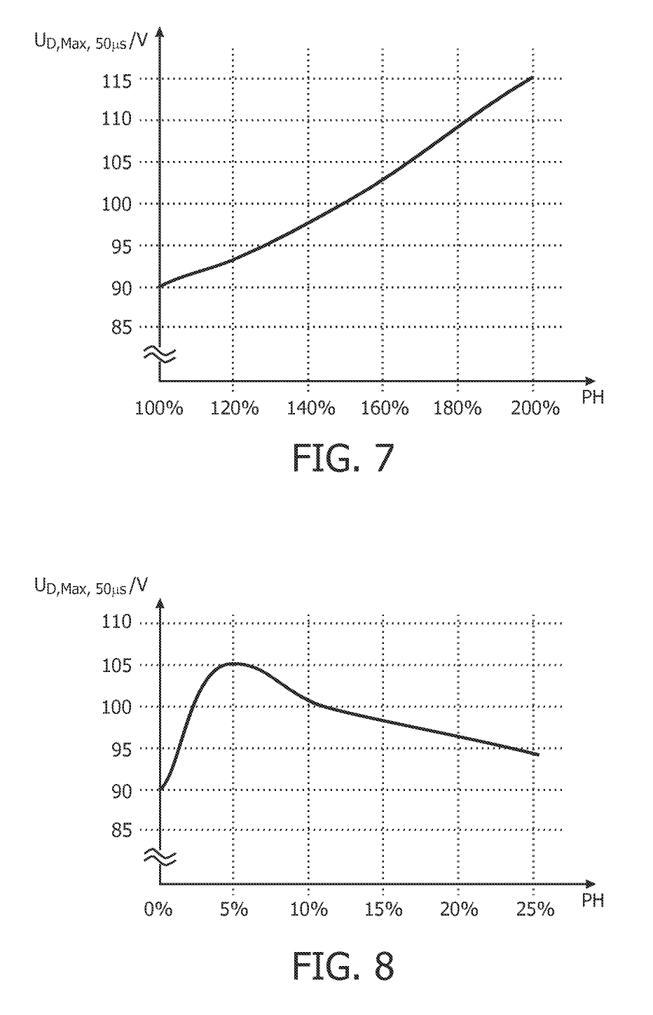

The present inventors have found that different values for the pulse width PW and the pulse height PH may be chosen to influence the dynamic voltage delivery capability of the driver 12. FIG. 7 shows a dependency of the maximum voltage U_{D} obtainable after the defined delivery time t_{D} of 50 μs after commutation in dependence on the pulse height PH. As shown, the dynamic capability of the driver 12 may thus be significantly influenced by the control applied from controller 40, without any further changes to the driver circuit 12. Thus, by choosing an appropriate pulse 50, a desired dynamic capability of the driver circuit 12 may be obtained.

However, it should be kept in mind that such pulses have drawbacks, such as increased losses and higher overall requirements for the elements of the circuit 30, such that the unnecessary application of pulses as well as unnecessarily high pulse height and width should be avoided. Especially, the pulsed operation may have a significant effect on the system supplying the electrical power for operation of the discharge lighting assembly, i. e. in the case of automotive lighting for the vehicle board net. The electrical power required is not constant, but increases during the pulse. These load variations have significant repercussions on the board net. Thus, in accordance with the present invention defined limitations on current pulses 50 supplied after commutation in the set current value Iₛₑₜ have been derived.

Regarding the pulse width PW, the present inventors have considered different pulse widths. FIG. 8 shows dynamic capability of the driver circuit 12 for pulses of 0% (no pulse) up to 25% of a half period duration. Satisfactory results have been obtained for pulse widths PW between 1% and 25% of a half period, preferably 2%-20%. An about optimal value has been established at 3-15% of a half period.

To achieve the desired variable dynamic capability of the driver circuit 12, the inventors propose to apply a pulse height PH dependent on lamp lifetime L. Generally, the pulse height PH applied to a newly manufactured lamp should be smaller than the pulse height PH applied to a lamp of a lamp lifetime of 2500 burning hours. The inventors have found that in some discharge assembly designs, no pulse (PH=100%) needs to be applied for an initial period of operation. After this, the pulse height PH should be raised to ensure commutation with successful re-ignition. As shown in FIG. 5 for the minimum curve (dashed line), the 90 V deliverable by the driver circuit 12 are sufficient up to the point 62 at 2000 h lamp age. In this minimum approach, it is sufficient to start with pulses 50 only after this initial period.

FIG. 6 shows how the pulse height PH (for a fixed pulse width PW of, in the present example, 10%) may be varied over lamp lifetime L. In FIG. 6, a solid line illustrates a recommended curve with values for the pulse height PH chosen high enough to guarantee successful commutation but still considerably low to limit resulting drawbacks. A dotted line shows a proposed maximum curve illustrating the highest values for the pulse height PH which offer a high security margin and are still deemed tolerable in terms of drawbacks. Similarly, the curve shown as a dashed line is a minimum curve illustrating the recommended minimum of commutation pulse height PH. It should, however, be emphasized that for the minimum curve of FIG. 5 there is only a very limited security margin. Thus, for pulses chosen between the minimum and maximum curves in FIG. 5, it may be expected that both the disadvantages and the rate of failure of lamps will still be tolerable. However, it is advisable to choose the pulse height PH closer to the optimum curve shown as a solid line in FIG. 6.

In the minimum curve of FIG. 6, no pulse operation (PH=100%) is applied in an initial interval up to a lamp age L of 2000 h. After L=2000 h (point 62), the pulse height PH is raised linearly with lamp life L up to a value of PH=125% at a lamp life L=2500 h. For operation beyond L=2500 h, it is preferred to continue the minimum curve linearly.

According to the maximum curve of FIG. 6, the pulse height PH starts at 150% for a newly manufactured lamp and increases already in an initial period of operation up to a value of PH=210% at L=500 h. From this time on, the pulse height PH is raised linearly such that at L=2000 h a pulse height PH=220% is reached. For operation beyond L=2000 h, the increase is continued linearly.

The proposed optimum curve of FIG. 6 shows no pulse operation (PH=100%) for a newly manufactured lamp in an initial interval of 450 h up to the point 60 of FIG. 5, where the required re-ignition voltage (plus the voltage drop over the inductance L1) supersedes the 90V available from the driver circuit 12 without pulses.

Thus, according to the optimum curve, pulse operation is proposed beyond 450 h of lamp lifetime L, with a pulse height PH at first raised linearly up to PH=120% at L=500 h. The pulse height PH is then further increased over lamp life time, although with a smaller slope, up to 155% at L=2000 h. For operation beyond L=2000 h, the curve continues with the same slope.

The operation as described above may be realized in the lighting assembly 30 by superimposing the pulses on the set current value Iₛₑₜ supplied by the outer constant power control loop. The corresponding pulse height and width values may be stored in a lookup-table. A microcontroller continuously determines the lifetime L of the lamp. The value of the lifetime L is then used in the lookup-table to determine the pulse height PH of the pulse which is superimposed on the rectangular wave form of the set current value Lₛₑₜ.

It has thus been shown how a set current value Iₛₑₜ comprising commutation pulses 50 where at least a part of the pulses 50 is applied after commutation, can serve to adjust the dynamic voltage delivery capability to ensure good commutation properties throughout the life time of a lamp 10 while avoiding unnecessary disadvantages.

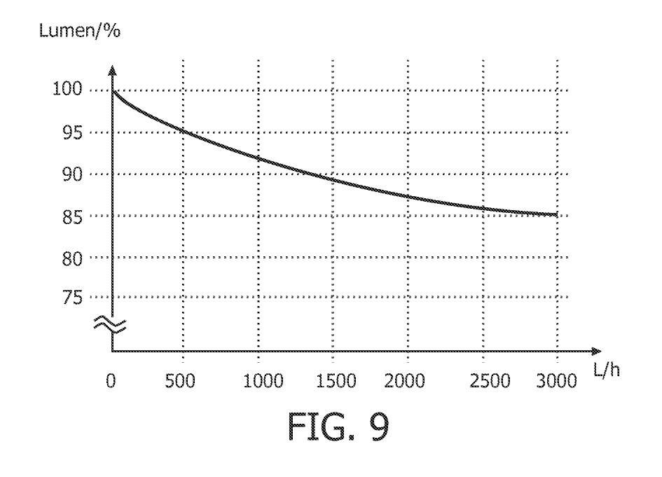

Applying pulses that increase in magnitude over the lamp lifetime L also has a further effect on operation of the lamp, namely on the lamp efficiency and thus the total luminous flux generated by the lamp 10. The lamp 10 is driven with constant operation power. The luminous flux generated by the lamp 10, which is measured in lumens (lm) and the lamp efficiency, i. e. luminous flux obtained divided by the electrical power, measured in lumens per Watt (lm/W) however generally decrease over the lamp lifetime L. This is known as lumen maintenance. FIG. 9 shows a diagram illustrating the dependency of the efficiency of the present sample 25 W lamp driven with pulses of constant pulse height PH and pulse width PW on the lifetime L. As shown, the lamp efficiency decreases over the lifetime L from an initial value of 86 lm/W (luminous flux of 2150 lm for the sample 25 W lamp) by about 15% within 3000 h of operation. If the lamp is driven with pulses on the lamp current I_{L}, the efficiency obtained can be increased. As shown in the following table 1, lamp efficiency in pulsed operation is increased over the basic efficiency obtained without pulses (PH=100%, PW=0%), and further increases with higher pulse height PH.

TABLE 1
Values for increase in lumen output for sample 25 W lamp

| | PW = 10% | PW = 20% | PW = 30% |
|---|---|---|---|
| PH = 100% | +/−0 lm | +/−0 lm | +/−0 lm |
| PH = 120% | +/−0 lm | +/−0 lm | +25 lm |
| PH = 150% | +125 lm | +150 lm | +125 lm |
| PH = 192% | +200 lm | +150 lm | +150 lm |

By applying increasing pulses over the lamp lifetime L, the efficiency loss may be counteracted to improve lumen maintenance. It is thus possible to eliminate, at least to a certain degree, a dependency of the lamp efficiency and thus total lumen output on the lifetime L of the lamp. This may be applied over the whole lifetime L or only in a certain lifetime interval of e.g. 500, 1000 or 2000h, specifically in an interval where the loss in efficiency is particularly noticeable. For example, the loss of about 10% of initial luminous flux shown in FIG. 9 may be tolerated, while from 1500 h to 3000 h an increasing pulse may be applied to shift the curve upwards.

In this context, it should be noted that an effect of increased efficiency may be obtained not only by pulses occurring shortly after commutation, such as pulses 50 in FIG. 4a, but also by pulses supplied at different times during each half period, such as e. g. pulses 52 shown in FIG. 4b occurring before commutation.

For a specific lamp, a dependency of the pulse height PH (or the pulse width PW, but it is preferred to keep PW constant at e. g. 5-10%) on the lamp lifetime L may be determined to achieve a constant or at least substantially constant lamp efficiency within the regarded lifetime interval. Corresponding pulses 50, 52 are then applied with a pulse height PH increasing in such a way, that the gained efficiency compensates the normal lifetime losses. As the skilled person will recognize, a corresponding curve may be determined that is located between the minimum and maximum curves of FIG. 6. Thus, a favourable dependency of the pulse height PH on the lamp lifetime L may be defined to achieve both stable commutation and improved lumen maintenance.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A discharge lighting assembly with
a discharge lamp (10) including a discharge vessel (20) with two electrodes (24) for forming an arc discharge,
a driver circuit (12) supplying electrical power to said lamp (10),
where said electrical power is supplied as an alternating lamp current (I_{L}) and/or an alternating lamp voltage (U_{L}) with a commutation between half periods of positive and negative values thereof,
where said driver circuit is controlled to be able to deliver at a predetermined delivery time (t_{D}) of 10-100 μs after commutation said electrical power at a voltage level (U_{D}) which varies over the lifetime (L) of said lamp (10).

2. Assembly according to claim 1, where
a controller (40) controls said driver circuit (12) to deliver said lamp current (I_{L}) and/or a lamp voltage (U_{L}) according to a set value (I_{Set}), where said set value (I_{Set}) comprises pulses (50) of a pulse height (PH),
which pulses (50) are located in time after commutation,
where a pulse height (PH) is defined as said set value (I_{Set}) relative to a plateau value (I_{Plateau}) delivered for the largest part of each half period,
and where said pulse height (PH) varies in dependence on the lifetime (L) of said lamp (10).

3. Assembly according to claim 2, where
said electrical power is supplied as an alternating lamp current (I_{L}),
and where said controller (40) controls said driver circuit (12) to deliver a lamp current (I_{L}) according to a set current value (I_{Set}), where said set current value (I_{Set}) comprises current pulses (50) of a pulse height (PH) which varies in dependence on the lifetime (L) of said lamp (10).

4. Assembly according to claim 2, where
said pulse height (PH) increases between a first pulse height value applied at a first, earlier time of said lifetime (L) of said lamp (10) and a second pulse height value applied at a second, later time of said lifetime (L) of said lamp (10).

5. Assembly according to claim 4, where
said pulse height (PH) increases monotonously between said first time and said second time.

6. Assembly according to claim 2, where
no pulses are provided within an initial interval up to a lifetime value,
and where pulses are provided after said lifetime value.

7. Assembly according to claim 2, where
a pulse height at 500 h of lifetime of said lamp (10) is 100% -210%,
and where a pulse height at 2225 h of lifetime of said lamp (10) is 110% -225%.

8. Assembly according to claim 2, where
a pulse height (PH) at 500 h of lifetime of said lamp (10) is 100% -140%,
and where a pulse height (PH) at 2000 h of lifetime of said lamp (10) is 130% -170%.

9. Assembly according to claim 2, where
said pulses have a pulse width (PW) of 1%-25% of the duration of a half period.

10. Assembly according to claim 1, where
a controller (40) controls said driver circuit (12) to deliver said lamp current (I_{L}) according to a set value (Iₛₑₜ),
where said set value (Iₛₑₜ) comprises pulses (50, 52) of a pulse height (PH) and a pulse width (PW),
where said pulse height (PH) and/or pulse width (PW) is determined, at least within a lifetime interval, to increase in dependence on the lifetime (L) of said lamp (10) to obtain a higher luminous flux as compared to operation with constant pulses.

11. Assembly according to claim 10, where
said pulse height (PH) is chosen to increase in dependence on said lifetime (L) such that said luminous flux is essentially constant within said lifetime interval.

12. Assembly according to claim 1, where
said discharge lamp (10) is driven with a time average electrical power of 20-30 W.

13. Assembly according to claim 1, where
said delivery time t_{D} is 50 μs.

14. Assembly according to claim 1, where
said discharge lamp (10) has a discharge vessel of a volume of 30 μl or less, filled with a rare gas of cold pressure of 10-20 bar and metal halides, where said filling is free of mercury,
and where said electrodes (24) are of cylindrical shape with a diameter of 150-400 μm.

15. A method of operating a discharge lamp (10) including a discharge vessel (20) with two electrodes (24) for forming an arc discharge,
where a driver circuit (12) supplies electrical power to said lamp (10) as an alternating lamp current (I_{L}) and/or an alternating lamp voltage (U_{L}) with a commutation between half periods of positive and negative values thereof,
where said driver circuit is controlled to be able to deliver at a predetermined delivery time (t_{D}) of 10-100 μs after commutation said electrical power at a voltage level which varies in dependence on the lifetime (L) of said lamp (10).
